(19) United States
(12) Patent Application Publication
(10) Pub. No.: US 2017/0286925 A1
(43) Pub. Date: Oct. 5, 2017

(54) SYSTEM AND METHOD FOR ACCUMULATING FUNDS INTO AN AGGREGATE ACCOUNT FOR TRANSACTING TRIGGERED PURCHASES

(71) Applicant: David Trubnikov, Delray Beach, FL (US)

(72) Inventor: David Trubnikov, Delray Beach, FL (US)

(21) Appl. No.: 15/428,458

(22) Filed: Feb. 9, 2017

Related U.S. Application Data
(60) Provisional application No. 62/316,541, filed on Mar. 31, 2016.

(51) Int. Cl. G06Q 20/10; G06Q 50/00; G06Q 20/28; G06Q 20/24

(52) U.S. Cl. CPC G06Q 20/10; G06Q 20/24; G06Q 50/01; G06Q 20/28

(57) ABSTRACT

A system and method used to pay for items in a future transaction by accumulating excess funds from an initial transaction. Funds from the initial transaction are rounded up to a predetermined monetary unit, and the difference between the cost and the rounded up amount is stored in an aggregate account. The account may then be used to pay for future transaction. In this manner, a user may accumulate funds in a transaction to pay for a future transaction at a more convenient time, and also accumulate funds in an easy convenient manner, apart from payroll deductions or rigid budgeting. Future transactions are triggered by an event, such as a preset date, a specific fund amount in aggregate account, or a time limit to complete future transactions. The items transacted in the future transaction are items that the user has designated for purchase with the funds in the account.

### CROSS REFERENCE OF RELATED APPLICATIONS

This application claims the benefits of U.S. provisional application No. 62/316,541, filed Mar. 31, 2016 and entitled SYSTEM OF ACCUMULATING FUNDS TO PAY FOR FUTURE TRANSACTIONS, which provisional application is incorporated by reference herein in its entirety.

### FIELD OF THE INVENTION

The present invention relates generally to a system and method for accumulating funds into an aggregate account for transacting triggered purchases. More so, the system and method accumulates funds from transactions by rounding up a transaction price to the nearest whole dollar amount or other monetary amount a user elects to have purchases rounded up to, and then automatically transferring the difference between the transaction amount and the rounded up amount into an aggregate account; whereby a future transaction that is triggered by an event is paid for through deduction from the aggregate account; and whereby additional funds can be specified to credit the aggregate account, in addition to the rounded up monetary unit.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that an electronic device that allows an individual to make electronic commerce transactions. This can include purchasing items on-line with a computer or using a smartphone to purchase something at a store. An individual's bank account can also be linked to the digital wallet. They might also have their driver's license, health card, loyalty card(s) and other ID documents stored on the phone.

Generally, an account holder can currently make deposits or payments to their accounts held by a financial institution using mail, a bank teller, an ATM, their employer making a direct payroll deposit, or by account transfer from another financial institutions. Often, a consumer saves funds in a bank account by making deposits into the account or by transferring funds from another account. Further, the consumer can automate the savings function by setting up recurring transfers from another account. However, the recurring transfer function is limited by the requirement to set a specific and minimum transfer amount and the need for the transfer to occur on a particular schedule. The recurring transfer function does not adequately support the flexibility of daily or small amount transfers.

Despite these various means to deposit funds into an account, consumers often have difficulty saving money. Those who make less than the median income level, or are raising families, or are new immigrants, find it particularly challenging to put money away for emergencies, a child's education, or a special purchase.

Other proposals have involved automated saving methods. The problem with these savings methods is that they require the consumer to consciously deposit funds into the account. Also, the accumulated funds are not automatically used for subsequent purchases to further encourage saving.

Even though the above cited savings methods meets some of the needs of the market, a system and method that accumulates funds from transactions by rounding up a transaction price to the nearest whole dollar amount, and then automatically transfers the difference between the transaction amount and the rounded up amount into an aggregate account, such that a future transaction that is triggered by an event is paid for through deduction from the aggregate account, and such that additional funds can be specified to credit the aggregate account, in addition to the rounded up monetary unit, is still desired.

### SUMMARY

Illustrative embodiments of the disclosure are generally directed to a system and method for accumulating funds into an aggregate account for transacting triggered purchases. In some embodiments, the method accumulates funds from transactions by rounding up a transaction price to the nearest whole dollar amount or other monetary amount a user elects to have purchases rounded up to, and then automatically transferring the difference between the transaction amount and the rounded up amount into an aggregate account.

The method continues by enabling future purchases to be paid for from the aggregate account. The future transactions can be triggered by an event, such as a preset date, a specific fund amount in the account, or a time limit to complete the future transaction. The items transacted in the future transaction are items that the user has designated for purchase with rounded up funds in the account. In this manner, the rounding up process, the transferring process, and the future transaction are fully automated.

Further, a user may specify an additional monetary unit to be deducted from an outside account, such as a checking account, or from the initial transaction. The additional monetary unit is added to the aggregate account for use in the future transaction. The additional monetary unit is in addition to the rounded up monetary unit and helps encourage additional saving. The additional monetary unit is calculated by rounding up, a tier based schedule, or a predetermined monetary unit by the user.

In one embodiment, the method may include an initial Step of registering to create a profile. A Step may then include selecting at least one item to purchase in a future transaction. A subsequent Step comprises linking a payment means to an aggregate account. Another Step involves performing an initial transaction through the payment means. Another Step may include rounding up the cost of the transaction to a rounded up monetary unit.

In some embodiments, a Step comprises transferring the difference between the cost of the initial transaction and the rounded up monetary unit amount to the account. Another Step includes triggering the future transaction based on at least one predetermined criteria. A Step may include paying for the future transaction from the aggregate account. A final Step comprises specifying an additional monetary unit to be deducted from the initial transaction, and added to the aggregate account for the future transaction, whereby the additional monetary unit is in addition to the rounded up monetary unit.

One objective of the present invention is to facilitate saving funds by rounding up for transactions and automatically transferring the rounded up amount to an aggregate account.

Another objective is to automate future transactions by enabling a triggering event to trigger predetermined purchases.

Yet another objective is to save time by automating transactions at predetermined durations.

Yet another objective is to enable automated linking of a payment means to the aggregate account.

Yet another objective is to provide opportunities to increase the aggregate account beyond rounding up, such as through periodic reloading of funds into the aggregate account.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for accumulating funds into an aggregate account for transacting triggered purchases, in accordance with an embodiment of the present invention; and

FIG. 2 illustrates a flowchart diagram of an exemplary method for accumulating funds into an aggregate account for transacting triggered purchases, in accordance with an embodiment of the present invention.

Like reference numerals refer to like parts throughout the various views of the drawings.

### DETAILED DESCRIPTION OF THE INVENTION

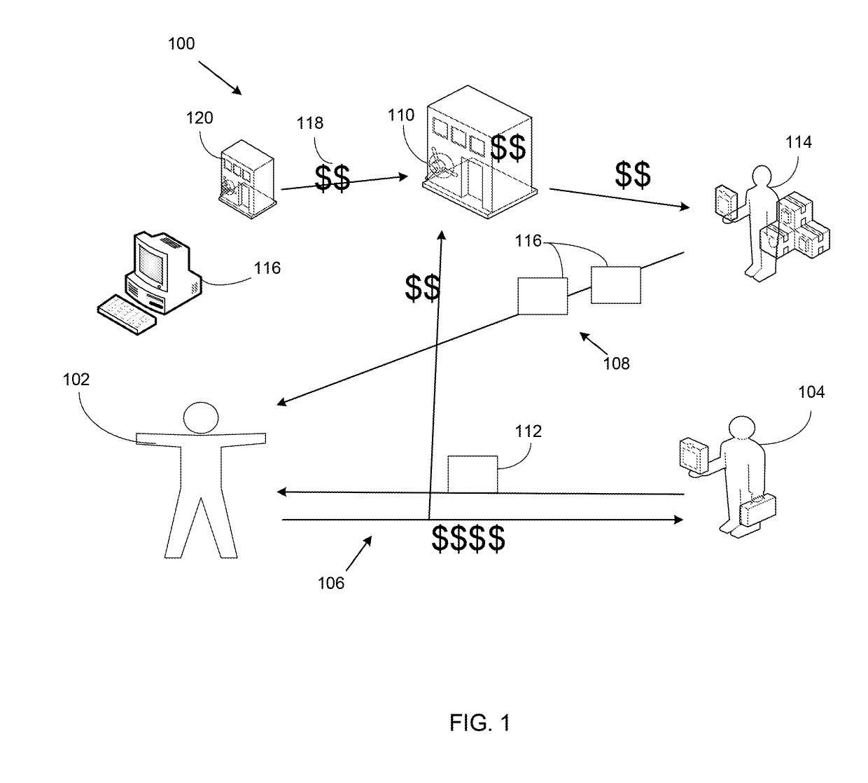

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

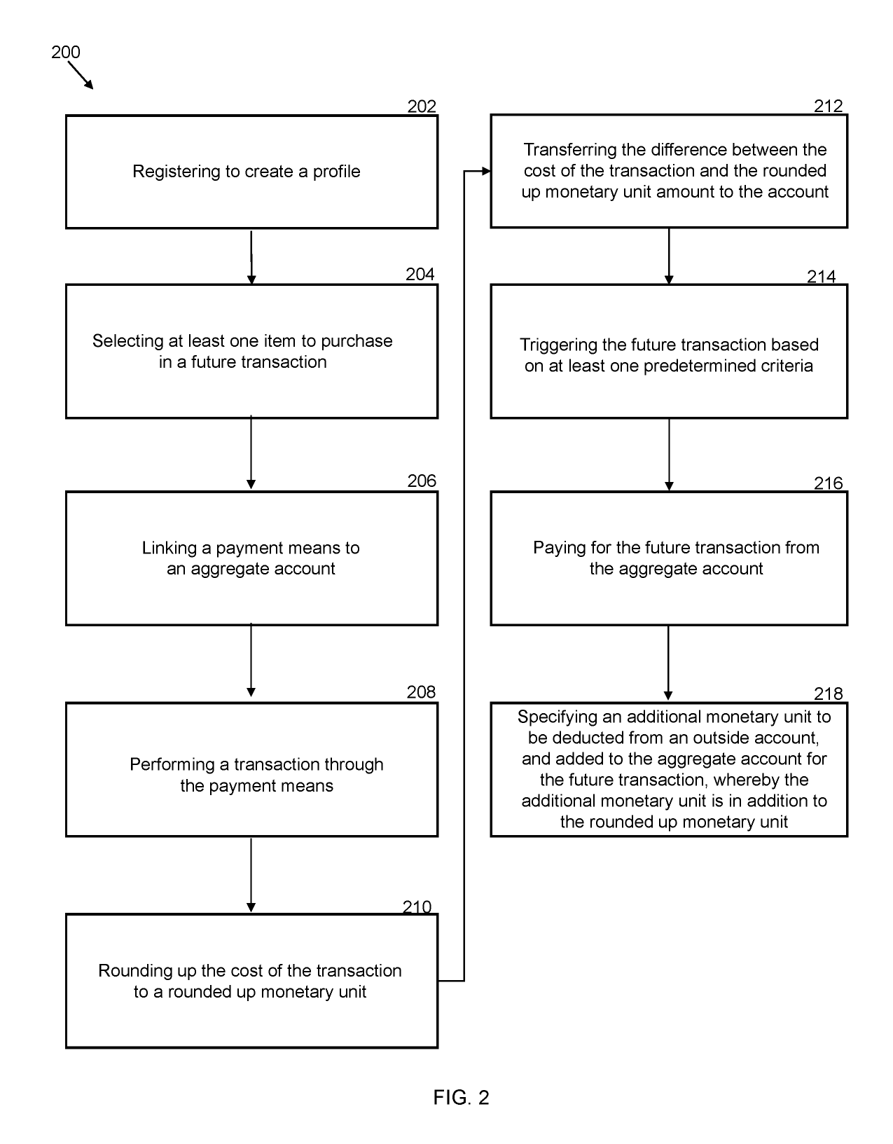

FIGS. 1 and 2 reference a system 100 and method 200 for accumulating funds into an aggregate account for transacting triggered purchases. In some embodiments, system 100 and method 200 provides an automated process for a consumer to accumulate rounded up funds from an initial transaction 106, automatically transfer the funds to an aggregate account 110, and transact future transaction 108 from the accumulated funds in the aggregate account 110, in response to a triggering event. Further, a user 102 may specify an additional monetary unit 118 to be deducted from an outside account 120, such as a checking account. The additional monetary unit 118 is added to aggregate account 110 for the future transaction 108. The additional monetary unit 118 is in addition to the rounded up monetary unit and helps encourage additional saving.

In some embodiments, system 100 and method 200 accumulates funds from an initial transaction 106 by rounding up a transaction price to the nearest whole dollar amount or other monetary amount a user elects to have purchases rounded up to, and then automatically transferring the difference between the transaction amount and the rounded up amount into an aggregate account. The method continues by enabling future purchases to be paid for from the aggregate account.

Future transactions 108 may be triggered by an event, such as a preset date, a specific fund amount in the account, or a time limit to complete the future transaction. The items transacted in the future transaction are items that the user has designated for purchase with rounded up funds in the account. In this manner, the rounding up process, the transferring process, and the future transaction are fully automated.

In one embodiment, the funds from initial transaction 106 are rounded up to a predetermined monetary unit, and the rounded up amount of the monetary unit is stored in the aggregate account 110. The purchase is rounded up to the nearest whole dollar amount or other amount the user elects to have purchases rounded up to. The difference is automatically transferred into a separate account.

For example, if a user 102 transacts a purchase of $27.50, the present invention would allow the user 102 to round-up 50 cents to the nearest dollar ($28.00). The 50 cents is then automatically transferred to an aggregate account. The accumulated funds in the aggregate account are then distributed to a future merchant 114 at the time of the transaction or at a later date. It is significant to note that the monetary unit stored in aggregate account 110 is not automatically claimed by a merchant 104. Aggregate account 110 is simply used as a marker for proof of past accumulation.

Once funds are accumulated therein, aggregate account 110 may then be used to pay for future transactions 108 that are triggered by an event. In this manner, user 102 may accumulate funds from activity of an initial transaction 106 to pay for a future transaction 108 at a more convenient time, and also accumulate funds in an easy convenient manner, apart from payroll deductions or rigid budgeting. Future transaction 108 can be automatically triggered by an event, such as a preset date, a specific fund amount in the aggregate account 110, or a time limit to complete the future transaction.

The items 112 transacted in future transaction 108 are items that user 102 has designated for purchase with the funds in the aggregate account 110. Examples may include periodic bills or secondary purchases dependent on a primary purchase, such as roofing supplies for a house that was purchased five years prior. Other exemplary items 112 for future transactions 108 may include, without limitation, a consumer good, a technology component, a food, a garment, a vehicle, a service, and a financial obligation. In another embodiment, the purchase of a first item triggers a purchase of a second item after a duration.

For example, without limitation, often the purchase of an initial product necessitates the purchase of one or more other products. The follow on products must often be purchased at a substantial expense to the purchaser. For example, when a person purchases a car, it is likely that the person will need new tires in about one and a half years. Tires can be a substantial expense. The person must also make periodic purchases of less costly items such as for gasoline, routine maintenance, and insurance. It is these subsequent purchases that are paid for by the aggregate account.

Those skilled in the art will recognize that consumers often have difficulty saving money. Those who make less than the median income level, or are raising families, or are new immigrants, find it particularly challenging to put money away for emergencies, a child's education, or a special purchase. Even affluent consumers who do have the means to save money often prefer to save more.

Often, a consumer saves funds in a bank account by making deposits into the account or by transferring funds from another account. Further, the consumer can automate the savings function by setting up recurring transfers from another account. However, the recurring transfer function is limited by the requirement to set a specific and minimum transfer amount and the need for the transfer to occur on a particular schedule. The recurring transfer function does not adequately support the flexibility of daily or small amount transfers. The present invention automates the accumulation of funds into an aggregate account that can be used to transact future purchases, and especially triggered purchases that are automated.

In one embodiment shown in FIG. 1, system 100 automatically transfers the difference between the transaction amount and the rounded up monetary unit amount to the aggregate account 110. This automated process occurs without requiring input or actions from the user 102 or a merchant 104.

Additionally, the system 100 transfers the funds, generally through transactions 106 that are conducted through electronic payments, such as credit cards, ATM withdrawals, debit cards, and bank transfers. However, in other embodiments, any payment process for initial transaction 106 may follow system 100, as indicated here. In one embodiment, the system 100 rounds up the transaction price to the nearest dollar. For example, initial transaction 106 for $3.15 is automatically rounded up to $4.00, with the excess $0.85 portion of the $4.00 transferring to the aggregate account 110.

In one alternative embodiment, user 102 has the option of specifying an additional monetary unit 118 to be deducted from each initial transaction 106 and added to the aggregate account 110, in addition to the rounded up monetary unit. The additional monetary unit 118 may be calculated in one of three ways: 1) rounding up to the nearest monetary unit from the initial transaction; 2) basing on a tiered schedule, i.e., items over $50 have $1 deducted as the additional monetary unit 118, items $50 to $100 have $2 deducted as the additional monetary unit 118, etc.; and 3) a predetermined amount form the user every period. In any case the additional monetary unit 118 is deducted from an outside account 120, such as a checking account to help encourage further savings.

In one embodiment, this opportunity to reload the aggregate account beyond the rounding up process is presented in a “Match” format option that matches the amount deducted or transferred between the aggregate account 110 and another account used for the initial transaction 106.

For example, user 102 specifies that an additional $1.00 should be added to the transaction 106 amount and transferred to the aggregate account 110, in addition to the rounded up monetary unit amount. Thus, from the above example, $1.40 would be transferred to the aggregate account 110, e.g., the $1.00 from the specified amount, and $0.40 from the rounded up monetary unit amount.

In some embodiments, the total cost for future transaction 108 may include, the price of the item 112; shipping costs; and a predetermined fee. As discussed above, system 100 may trigger the future transaction 108 when the cost of item 112 reaches a predetermined cost, or after a predetermined time period. The shipping costs are variable, based on distance. Though direct pickup of the item 112 may negate shipping costs.

It is also significant to note that in case a user 102 changes their mind about performing the future transaction 108, or decides to cancel one altogether, any funds accumulated in the aggregate account 110 with that specific merchant 104 will stay there.

In one embodiment, a fee may be imposed for cancelling the future transaction 108. The funds will never expire and can be used in the future for any purchases with that specific merchant 104. Additionally, any funds accumulated by a user's 102 aggregate account 110 go directly to a second merchant 114 and not into any initial savings account. No funds accumulated are ever lost. In one embodiment, the accumulated funds in the aggregate account 110 are handled by an account server 116 within a credit card processing system.

In some embodiments, items 112 included in future transaction 108 may be predetermined, based on items 112 that the user 102 has designated for purchase with the funds in the aggregate account 110. In one alternative embodiment, the predetermined items 112 form a “Wish Wallet” that is created by the user 102. The user 102 must create the Wish Wallet prior to participating in the system 100. In one embodiment, merchant 104 may designate a site for members of a network, e.g., Wish Wallet members to sign in through an online store. For example, a designated cart labeled Wish Wallet becomes available to add future items 116 for the future transaction 108.

There are different types of events that can trigger the aggregate account 110 to automatically perform the future transaction 108. In some embodiments, the event is a time period or date that triggers the future transaction 108. This can be a “Wish Date”. At the Wish Date, the future transaction 108 is performed with at least a portion of the costs, if not all, paid for from aggregate account 110. Typical Wish Dates may include birthdays, anniversaries, holidays, and social events.

For example, user 102 buys a necklace online with the entire order totaling $50. It is for a family member's birthday which is in a month, or exactly 30 days. The future merchant 108 estimates delivery time of 3-5 days. User 102 presets a Wish Date for the necklace a week, or 7 days, before the birthday to ensure the necklace arrives on time. Ideally, the aggregate account 110 should have sufficient funds in 23 days to cover the $50, plus shipping, and any other fees.

Another event that can trigger the future transaction 108 occurs when the funds in aggregate account 110 reaches a predetermined monetary amount, or a “Wish Price” determined by the user 102. At this point, system 100 may automatically trigger the future transaction 108. In one scenario, if the aggregate account 110 has accumulated the $50 before the birthday shipping date, the necklace automatically ships out.

However, in another scenario, if the aggregate account 110 has only accumulated $40 at the deadline to ship the necklace, the system 100 automatically deducts the extra $10 from a credit card of the user 102. In either scenario, the user 102 is notified of the actions through texts, emails, telephone calls, or other alerts known in the art.

Yet another event can occur if a future item 116 that is targeted as a future transaction 108 reaches a predetermined price point. At this point, the system 100 may automatically conduct future transaction 108. In this manner, user 102 has the option to specify the specifics about the future transaction 108 triggering criteria. In yet another event future merchant 114 may set a Merchant Wish Date by requiring the future transaction 108 to be performed at a preset date. This will set a time limit on how long the user 102 has to accumulate funds in the aggregate account 110 before performing the future transaction 108.

In some embodiments, future items 116 that don't have a set Wish Date and are from the same future merchant 114 can be grouped into the same shipment to save on shipping costs. The future transactions 108 are chronologically ordered in case the user 102 has reached the Wish Price for the future item 116 they put on the list and would like to have the future item 116 sooner.

In this cost saving structure, an alert is sent to the user 102 indicating that the future item 116 can be grouped with other future items 116 for shipment. This give the user 102 the option to have the future item 116 sent out right away or wait until the other future item 116 from the same future merchants 114 have reached their Wish Prices as well. Though, the shipping costs for different users 102 will vary, depending on distance shipped and weight of the future item 116.

In one embodiment, the system 100 helps save money for the user 102 and the future merchant 114 by cutting shipping costs through a “Group Wish”. This feature allows the user 102 to group their purchases into one shipment as long as the items 112 are from the same future merchant 114. The user 102 is not required to set a Wish Date. This will save the user 102 money and they will be inclined to buy more from the same future merchant 114.

In some embodiments, system 100 generates revenue by charging a predetermined fee to the user 102 to register and use the system 100. The predetermined fee can be based on the final price paid by the aggregate account 110 during the future transaction 108. For example, assuming a 3% fee, a $100 future transaction 108 fully paid for from the aggregate account 110 would require the user 102 to pay $103. However, if the user 102 only pays $60 from the aggregate account 110, and the balance of $40 from another source, the predetermined fee of 3% would only be applied to the $60. However, in other embodiments, the user 102 may select to pay a periodic set fee in lieu of the predetermined fee as a percentage of total cost.

In some embodiments, future merchant 114 may require the user 102 to prepay a down payment for the future transaction 108 before the funds from transactions 106 can begin accumulating in the aggregate account 110. For example, the user 102 wants to place an order of $20 and the merchant 104 wants a down payment of $5 on it. After paying the $5 up front, the user 102 can now take the extra time necessary to accumulate the $15 item cost, plus additional fees, e.g., 3% service fee, to satisfy the final costs of the future transaction 108. It is significant to note that the additional fees are imposed solely for the funds accumulated by the user 102.

Furthermore, as stated above, the $15 is accumulated by rounding up monetary unit amounts for the transactions 106.

In some embodiments, the network, e.g., Wish Wallet members can be accompanied by progress charts and alerts to allow the user 102 to keep detailed track of their orders. The progress charts may indicate: what future items 116 are on the user's 102 Wish List, the order that the future items 116 are in to be delivered, the cost breakdown of each order, and how close the user 102 is to conducting the future transaction 108. Furthermore, at any point, the user 102 may remove or add future items 116 to the Wish Wallet. The user 102 may also check online to verify the status of the funds in the aggregate account 110, or change the events that trigger the future transaction 108.

In some embodiments, system 100 sends out an alert to indicate when the future transaction 108 has been fulfilled, or when the aggregate account 110 has reached a predetermined monetary unit amount, or to suggest similar items 112 for sale. The alert may include, without limitation, a text, a phone call, an email, a social network notification, and a letter in the mail.

In some embodiments, the user 102 may integrate a social network, such as Facebook, Twitter, or LinkedIn, into the system 100 to enhance the transaction 106 and future transaction 108 experience, and inform other members of the social network about the transactions 106, 108. For example, the user 102 may communicate the details of the future transaction 108, the merchant 104, and the prices for the items 112, 116 on the social network, so that other members can view and interact accordingly.

Typical functions on the social network that may create synergy with the system 100 may include leaving comments and reviews on purchases made and experiences with things like the product, retailer, or the service. In one example, users 102 can add merchants 104 as friends on their social network to receive promotions from the respected merchant 104 along with advertisements and suggested items according to past transactions with all merchants 104 in the user's social circle. The merchant 104 may pay a fee to join this network.

Through the use of the social network, the user 102 may also give gift ideas to friends that include pictures and the direct link to the merchants 104, 114 checkout page. And if “Friended”, or identified in some manner on the social network, the user 102 may view items 112, 116 on other lists and receive suggestions for purchase for upcoming events, such as birthdays and weddings.

User 102 also has the option of viewing other members on the social network and conducting the future transaction 108 on their behalf with the user's 102 aggregate account 110. In an alternative embodiment, a user 102 may communicate their specific goal through the social network such as a “Birthday Wish” or “Wedding Wish” with a specific item in mind. Other users can then link themselves to that user's 102 Wish Wallet to speed up the accumulation process.

In some embodiments, the future merchant 114 benefits greatly through the future transactions 108 being conducted in this manner. As discussed above the future merchant 114 collects a predetermined fee. However, the future merchant 114 also benefits in numerous other ways. In one embodiment, the future merchant 114 attracts new customers as the future merchant's 114 service appeals to a vast audience of online shoppers with all types of spending patterns. The future merchant 114 also increases customer retention and satisfaction as this service will be simple, convenient and refreshing to use.

In another example of the future merchant 114 benefiting, the future merchant 114 can increase the number of orders as the system 100 allows customers to pay over time. The future merchant 114 also reduces online shopping cart abandonment by creating simple and transparent goals that can be tracked by the user 102. The future merchant 114 has the opportunity to see their customer spending patterns with other vendors i.e. what they buy and how often. Additionally, the social network will encourage more sales as users 102 and potential customers will be in touch with each other and what their friends are buying.

It is also significant to note that the system 100 is configured to inhibit the user 102 from cancelling the future transaction 108 at the checkout page of the future merchant 114. For one, the price of the future item 116 is automatically deducted from the aggregate account 110, which is remote, and not connected directly to the user's 102 bank account. This makes the cost of the future item 116 seem less intimidating.

Additionally, system 100 indicates the price prior to future transaction 108 occurring. So user 102 is aware of the full amount expected to pay. Another effect of system 100 is that the funds in aggregate account 110 cannot be spent on any ancillary future item 116 or services. Rather the funds are focused on the predetermined future transaction 108, which requires registering with future merchant 114 and other significant acts. Finally, since the payment for final transaction 106 is automated, user 102 does not have to face a complex checkout process online. Rather, every aspect of the future transaction 108 is predetermined and often triggered by events that simplify the future transaction 108.

FIG. 2 illustrates a flowchart diagram of an exemplary method 200 for accumulating funds into an aggregate account for transacting triggered purchases. The method 200 may be used to pay for future items 116 in a future transaction 108 by accumulating excess funds from a transaction 106. The funds from the transaction 106 are rounded up to a predetermined monetary unit, and the rounded up amount of the monetary unit is stored in an aggregate account 110. The aggregate account 110 may then be used to pay for future transactions 108.

The method 200 may include an initial Step 202 of registering to create a profile. The user 102 may register by providing personal information and financial information. A Step 204 may include selecting at least one item to purchase in a future transaction. The items for future transaction may include products or services that are purchased periodically, or items that are dependent on the initial transaction 106. For example an electric bill that is due every month, or tires and oil changes for a vehicle that was purchased two years prior. However in other embodiments, a purchase of any product or service may be selected for future transactions 108.

Method 200 may further comprise a Step 206 of linking a payment means to an aggregate account 110. The payment means may include a credit card that can be charged if the aggregate account 110 has insufficient funds to pay for the future transaction 108. Online payment companies, gift cards, and electronic wallets may also be used.

A Step 208 includes performing an initial transaction 106 through the payment means. The initial transaction 106 includes purchasing a product or service. The initial transaction 106 may include a purchase of any product or service.

In some embodiments, a Step 210 comprises rounding up the cost of the transaction 106 to a predetermined monetary unit. The rounding up can be to the nearest dollar amount. Though the user 102 can specify that additional amounts can be added. A Step 210 includes transferring the rounded up monetary unit amount to the aggregate account 110. The account is a remote server that stores and regulates the transfer of funds. The user 02 can access the server at any time.

In some embodiments, a Step 212 may include transferring the difference between the cost of the initial transaction and the rounded up monetary unit amount to the account.

A Step 214 comprises triggering the future transaction 108 based on at least one predetermined criteria. There are different types of events that can trigger the aggregate account 110 to automatically perform the future transaction 108. In some embodiments, the event is a time period or date that triggers the future transaction 108. One exemplary format for the event is a “Wish Date”. Yet another event can occur if a future item 116 that is targeted as a future transaction 108 reaches a predetermined price point.

A Step 216 includes paying for the future transaction 108 from the aggregate account 110. In one embodiment, the total cost for the future transaction 108 may include, the price of the item 112; shipping costs; and a predetermined fee. However in other embodiments, other costs may be incurred.

A final Step 218 comprises specifying an additional monetary unit to be deducted from an outside account, and added to the aggregate account for the future transaction, whereby the additional monetary unit 118 is in addition to the rounded up monetary unit.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for accumulating funds into an aggregate account for transacting triggered purchases, the method comprising:
registering to create a profile;
selecting at least one item to purchase in a future transaction;
linking a payment means to an aggregate account;
performing an initial transaction through the payment means;
rounding up the cost of the initial transaction to a rounded up monetary unit;
transferring the difference between the cost of the initial transaction and the rounded up monetary unit amount to the aggregate account;
triggering the future transaction based on at least one predetermined criteria;
paying for the future transaction from the aggregate account; and
specifying an additional monetary unit to be deducted from an outside account and added to the aggregate account for the future transaction, whereby the additional monetary unit is in addition to the rounded up monetary unit.

2. The method of claim 1, wherein the cost of the initial transaction is rounded up to the nearest dollar.

3. The method of claim 1, wherein the predetermined criteria is a predetermined fund amount in the account, or a predetermined date.

4. The method of claim 1, wherein the rounded up monetary unit amount in the account is handled by an account server within a credit card processing system.

5. The method of claim 1, wherein the initial transaction occurs online.

6. The method of claim 1, wherein the initial transaction is paid for with a credit card.

7. The method of claim 1, wherein a merchant charges a fee in addition to the cost of the initial transaction.

8. The method of claim 1, wherein a future merchant charges a fee in addition to the cost of the future transaction.

9. The method of claim 1, further including the step of interacting with a social network.

10. A method for accumulating funds into an aggregate account for transacting triggered purchases, the method comprising:
registering to create a profile;
selecting at least one item to purchase in a future transaction;
linking a payment means to an aggregate account;
performing an initial transaction through the payment means;
rounding up the cost of the transaction to a rounded up monetary unit;
transferring the difference between the cost of the initial transaction and the rounded up monetary unit amount to the aggregate account;
triggering the future transaction based on at least one predetermined criteria;
paying for the future transaction from the aggregate account;
specifying an additional monetary unit to be deducted from an outside account, and added to the aggregate account for the future transaction, whereby the additional monetary unit is in addition to the rounded up monetary unit;
interacting with a social network; and
charging a fee in addition to the future transaction.

11. The method of claim 10, wherein the cost of the initial transaction is rounded up to the nearest dollar.

12. The method of claim 10, wherein the predetermined criteria is a predetermined fund amount in the account or a predetermined date.

13. The method of claim 10, wherein the rounded up monetary unit amount in the account is handled by an account server within a credit card processing system.

14. The method of claim 10, wherein the initial transaction occurs online.

15. The method of claim 10, wherein the initial transaction is paid for with a credit card.

16. The method of claim 10, wherein a merchant charges a fee in addition to the cost of the initial transaction.

17. The method of claim 10, wherein a future merchant charges a fee in addition to the cost of the future transaction.

18. A system for accumulating funds into an aggregate account for transacting triggered purchases, the system comprising:
a user operable to make an initial transaction for at least one item;
a merchant operable to perform the initial transaction with the user for a cost of the initial transaction, whereby the cost of the initial transaction is rounded up to a monetary unit;
an aggregate account configured to receive the difference between the cost of the initial transaction and the rounded up monetary unit amount;
an account server operatively linked to the aggregate account, the account server configured to control and transfer the difference between the cost of the initial transaction and the rounded up monetary unit amount in the aggregate account; and
a future merchant operable to perform a future transaction with the user, whereby the future transaction is funded from the aggregate account.

19. The system of claim 18, wherein the merchant, or the future merchant, or both, charge a fee in addition to the cost of the transactions.

20. The system of claim 18, wherein the cost of the initial transaction is rounded up to the nearest dollar.
